(19) United States
(12) Patent Application Publication
(10) Pub. No.: US 2009/0049516 A1
(43) Pub. Date: Feb. 19, 2009

(54) COMMUNICATION RELAY METHOD AND APPARATUS AND COMMUNICATION RELAY CONTROL METHOD AND APPARATUS

(75) Inventors: Hyok-sung CHOI, Seoul (KR); Hee-seok Yu, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/174,877

(22) Filed: Jul. 17, 2008

Related U.S. Application Data
(60) Provisional application No. 60/956,201, filed on Aug. 16, 2007.

(30) Foreign Application Priority Data
Dec. 27, 2007 (KR) 10-2007-0138599

(51) Int. Cl. H04L 9/00

(52) U.S. Cl. 726/1

(57) ABSTRACT

Provided are a method and apparatus for relaying a communication between a terminal and an external communication network, and a method and apparatus for controlling a relay of a communication between a terminal and an external communication network. The method includes receiving safety policy information of the terminal from an external server that stores a plurality of pieces of safety policy information used to control a communication between at least one terminal and the external communication network.

### CROSS-REFERENCE TO RELATED PATENT APPLICATIONS

This application claims the benefit of U.S. Provisional Application No. 60/956,201, filed on Aug. 16, 2007, in the U.S. Patent and Trademark Office, and the Korean Patent Application No. 10-2007-0138599, filed on Dec. 27, 2007, in the Korean Intellectual Property Office, the disclosures of which are incorporated herein in their entirety by reference.

### BACKGROUND OF THE INVENTION

1. Field of the Invention

The present invention relates to a communication relay method and apparatus and communication relay control method and apparatus, and more particularly, to a method and apparatus for relaying a communication between a terminal and an external communication network and a method and apparatus for controlling a device for relaying the communication between the terminal and the external communication network.

2. Description of the Related Art

Due to the development of information communication technology, active transmission of data over the Internet has been occurring. Nevertheless, safe access by a user terminal to all websites is impossible, because some websites threaten the security of the user terminal by infecting the user terminal with a virus or by distributing a malicious code to the user terminal. To address these problems, the user terminal conventionally accesses the Internet through a proxy server.

FIG. 1 illustrates a communication system 100 including a proxy server 120 according to a conventional art. Referring to FIG. 1, the communication system 100 comprises an Internet 110, the proxy server 120, and three user terminals 130.

The three user terminals 130 are connected to Internet 110 through the proxy server 120 in which Internet websites that are not to be accessed by the user terminals 130 are internally registered. These Internet websites threaten the security of the three user terminals 130 by infecting the three user terminals 130 with a virus or by distributing a malicious code to the three user terminals 130.

Each of the first through third user terminals 131 through 133 similarly performs communication with Internet 110 and thus the first user terminal 131 will now be described.

The proxy server 120 determines if a website requested by the first user terminal 131 is unavailable. If the website is determined to be unavailable, the proxy server 120 informs the first user terminal 131 that the website is unavailable. Meanwhile, if the website is determined to be available, the proxy server 120 relays a communication between the first user terminal 131 and Internet 110.

When the communication between the first user terminal 131 and Internet 110 is relayed, the proxy server 120 determines if data requested by the first user terminal 131 is stored in an internal storage space of the proxy server 120. If the data is stored in the internal storage space of the proxy server 120, the proxy server 120 transmits the stored data to the first user terminal 131. Meanwhile, if the data is not stored in the internal storage space of the proxy server 120, the proxy server 120 receives the data through Internet 110, and transmits the received data to the first user terminal 131. In this regard, the data transmitted to the first user terminal 131 is stored in the internal storage space of the proxy server 120.

The conventional proxy server 120 makes it possible to safely connect the three user terminals 130 to Internet 110 and promptly transfer data desired by the three user terminals 130 by using a data caching function.

However, one proxy server 120 must process a connection request of the three user terminals 130, which increases the burden on the proxy server 120. In particular, when the proxy server 120 does not operate normally due to bad performance or a malfunction thereof, the three user terminals 130 all fail to connect to Internet 110. Thus, the three user terminals 130 are sensitive to the performance of the proxy server 120 in terms of communication quality, and it is expensive to sustain and repair the proxy server 120 in order to ensure the communication quality.

In particular, the proxy server 120 applies the same safety policy to the three user terminals 130, which prevents a specialized safety policy from being applied to the first user terminal 131. For example, if a user of the first user terminal 131 is ten years old, more websites may have to be limited to the user of the first terminal 131 than users of the second and third terminals 132 and 133. Nevertheless, it is required to apply the same safety policy to all three user terminals 130.

Furthermore, although the proxy server 120 includes internal storage space in order to perform a caching function thereof, the three user terminals 130 include respective storage spaces, leading to an unnecessary consumption of storage space.

### SUMMARY OF THE INVENTION

The present invention provides a communication relay method and apparatus, and communication relay control method and apparatus in order to provide a specialized safety policy to each user terminal.

According to an aspect of the present invention, there is provided a method of relaying a communication between a terminal and an external communication network, the method comprising: receiving safety policy information of the terminal from an external server that stores a plurality of pieces of safety policy information used to control a communication between at least one terminal and the external communication network; and determining whether to allow the communication between the terminal and the external communication network based on the safety policy information.

The method may further comprise: generating communication detail information that induces an update of the safety policy information of the terminal based on a result of the communication between the terminal and the external communication network; and transmitting the communication detail information to the external server.

The safety policy information may include at least one of virus information on a predetermined address space in the external communication network, malicious code information, and access limit information with regard to the terminal.

The method may further comprise: if the communication between the terminal and the external communication network is allowed, determining whether data requested by the terminal is stored in a predetermined storage space; and selectively relaying the communication between the terminal and the external communication network based on a result of the determination.

The selectively relaying of the communication may comprise: if the data requested by the terminal is stored in the predetermined storage space, transmitting the stored data to the terminal.

The selectively relaying of the communication may comprise: if the data requested by the terminal is not stored in the predetermined storage space, receiving the data requested by the terminal from the external communication network; transmitting the received data to the terminal; and storing the received data in the predetermined storage space.

At least one of the receiving of the safety policy information and the determining is performed in the terminal.

According to another aspect of the present invention, there is provided a method of controlling a relay of a communication between a terminal and an external communication network, the method comprising: collecting safety policy information of at least one terminal in order to control a communication between the at least one terminal and the external communication network; and transmitting the safety policy information of the terminal among the collected safety policy information to the terminal.

The method may further comprise: receiving communication detail information relating to the terminal from the terminal based on a result of the communication between the terminal and the external communication network; and updating the safety policy information of the terminal based on the received communication detail information.

The safety policy information may include at least one of virus information on a predetermined address space in the external communication network, malicious code information, and access limit information with regard to the terminal.

The safety policy information may include first safety policy information used to control the communication between the terminal and the external communication network and a second safety policy information used to commonly control the communication between the at least one terminal and the external communication network.

According to another aspect of the present invention, there is provided an apparatus for relaying a communication between a terminal and an external communication network, the apparatus comprising: a safety policy information receiving unit which receives safety policy information of the terminal from an external server that stores a plurality of pieces of safety policy information used to control a communication between at least one terminal and the external communication network; and a communication allowable determining unit which determines whether to allow the communication between the terminal and the external communication network based on the safety policy information.

The apparatus may further comprise: an information generating unit which generates communication detail information that induces an update of the safety policy information of the terminal based on a result of the communication between the terminal and the external communication network; and an information transmitting unit which transmits the communication detail information to the external server.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a communication system including a proxy server according to a conventional art;

FIG. 2 is a block diagram of a communication relay apparatus according to an exemplary embodiment of the present invention;

FIG. 3 is a detailed block diagram of the communication relay apparatus shown in FIG. 2;

FIG. 4 is a block diagram of a communication relay control apparatus for controlling the communication relay apparatus shown in FIG. 2 according to an exemplary embodiment of the present invention;

FIG. 5 is a flowchart illustrating a communication relay method according to an exemplary embodiment of the present invention;

FIG. 6 is a flowchart illustrating a communication relay control method according to an embodiment of the present invention; and

FIG. 7 illustrates an operation of a communication system including the communication relay apparatus shown in FIG. 2 and the communication relay control apparatus shown in FIG. 4 according to another exemplary embodiment of the present invention.

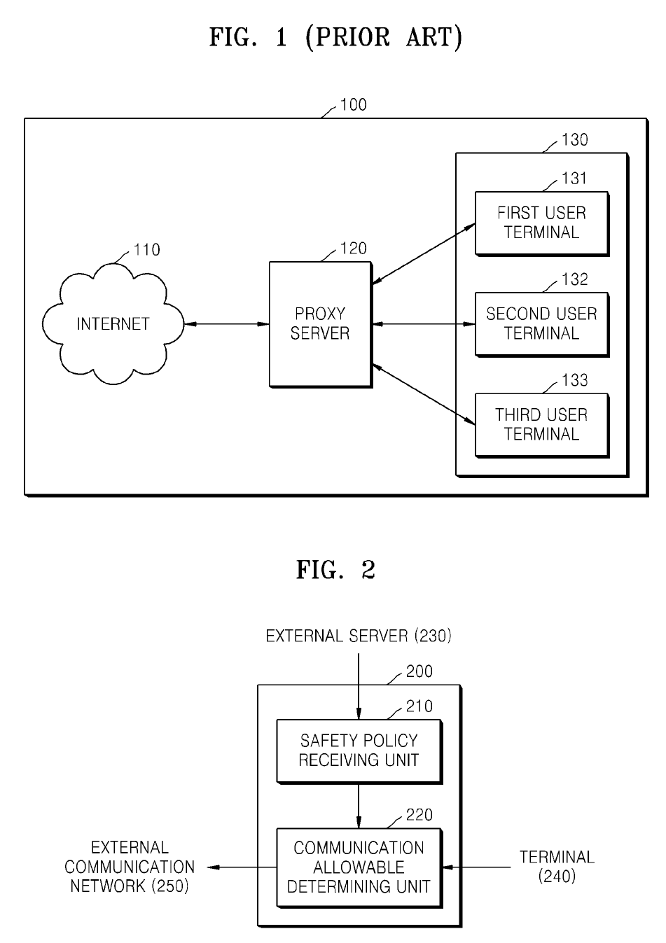

### DETAILED DESCRIPTION OF EXEMPLARY EMBODIMENTS OF THE INVENTION

Exemplary embodiments of the present invention will now be described more fully with reference to the accompanying drawings.

FIG. 2 is a block diagram of a communication relay apparatus 200 according to an embodiment of the present invention. Referring to FIG. 2, the communication relay apparatus 200 comprises a safety policy receiving unit 210 and a communication allowable determining unit 220.

The safety policy receiving unit 210 receives safety policy information of a terminal 240 from an external server 230. The external server 230 stores pieces of safety policy information used to control a communication between at least one terminal and an external communication network 250. The safety policy information of the terminal 240 includes at least one of virus information on a predetermined address space in the external communication network, malicious code information, and access limit information with regard to the terminal 240.

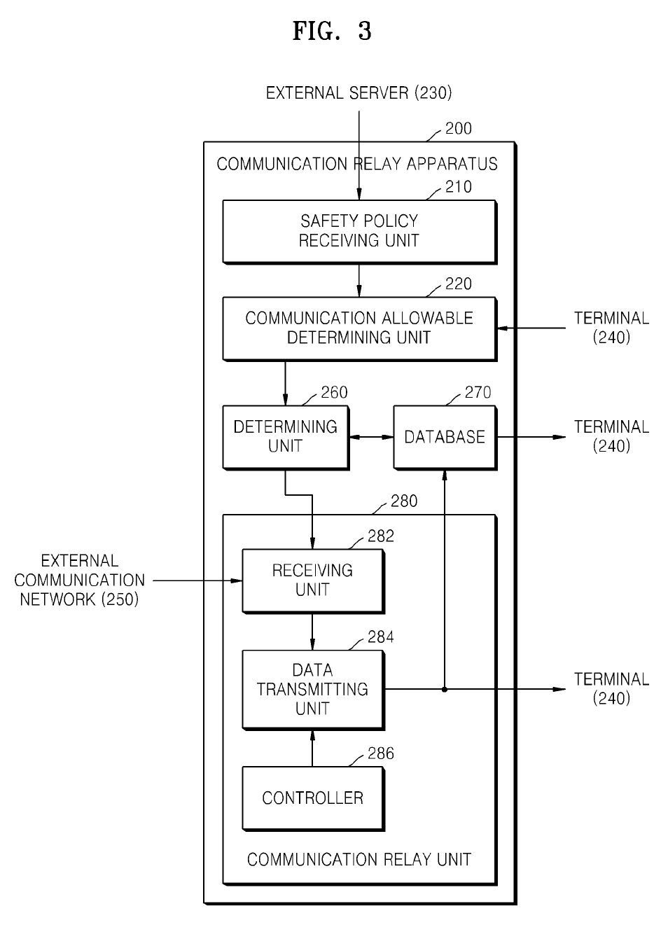

The communication allowable determining unit 220 determines whether to allow a communication between the terminal 240 and the external communication network 250 based on the safety policy information. For example, the safety policy information corresponding to the terminal 240 may include information relating to a detection of a virus in data provided by a website A, a distribution of a malicious code in a website B, and content that is improper to the terminal 240 stored in a website C. Thus, if the terminal 240 requests connection to the websites A, B, and C, the communication allowable determining unit 220 blocks the connection of the terminal 240 to the corresponding website. If the communication allowable determining unit 220 allows the communication between the terminal 240 and the external communication network 250, a subsequent operation of the communication relay apparatus 200 will be described in detail with reference to FIG. 3.

The communication relay apparatus 200 may further comprise an information generating unit (not shown) and an information transmitting unit (not shown).

The information generating unit (not shown) generates communication detail information that induces update of the safety policy information of the terminal 240 based on a result of the communication between the terminal 240 and the external communication network 250. The communication detail information can include any type of information that can be obtained from the communication between the terminal 240 and the external communication network 250. For example, information indicating that a connection between the terminal 240 and a specific website fails or is delayed, information that data provided by the specific website is inappropriate for a user of the terminal 240, information on a website susceptible to a virus infection, or information on a website distributing a malicious code to the terminal 240 is obtained from the communication between the terminal 240 and the external communication network 250, and all types of information used to induce the update of the safety policy information are possible.

The information transmitting unit (not shown) may further generate additional information in addition to the communication detail information used to induce the update of the safety policy information. In the present specification, although the additional information is not related to the update of the safety policy information, it is information relating to the terminal 240. For example, the additional information may include information on a malfunction of the communication relay apparatus 200, information on a favorite website of the terminal 240 based on a connection number or time of the terminal 240 to a specific website, or information on an application mainly executing in the terminal 240, and the like. The additional information can be used as a reference material in the future when the communication relay apparatus 200 is out of order or can be utilized in another application using priority of the terminal 240.

The information transmitting unit (not shown) transmits the communication detail information to the external server 230 in order to induce the update of the safety policy information of the terminal 240.

Although the communication relay apparatus 200 can be excluded from the terminal 240, it is preferably included in the terminal 240. When the communication relay apparatus 200 is included in the terminal 240, the communication relay apparatus 200 may further include an operation controller (not shown) for controlling an operation of an application executing in the terminal 240. The operation controller (not shown) receives information on an application to be performed by the terminal 240, determines whether the application meets the safety policy information received by the safety policy receiving unit 210, if the application meets the safety policy information, controls the application to be executed, and, if the application does not meet the safety policy information, controls the application not to be executed.

FIG. 3 is a detailed block diagram of the communication relay apparatus 200 shown in FIG. 2. Referring to FIG. 3, the communication relay apparatus 200 comprises the safety policy receiving unit 210, the communication allowable determining unit 220, a determining unit 260, a database 270, and a communication relay unit 280.

The elements denoting the same reference numerals are described with reference to FIG. 2 and thus its description is not repeated.

When the communication allowable determining unit 220 allows the communication between the terminal 240 and the external communication network 250, the determining unit 260 determines whether data requested by the terminal 240 is stored in the database 270.

The communication relay unit 280 selectively relays the communication between the terminal 240 and the external communication network 250 based on the determination of the determining unit 260.

If the determining unit 260 determines that the data requested by the terminal 240 is stored in the database 270, the communication relay unit 280 does not relay the communication between the terminal 240 and the external communication network 250. Instead, the communication relay unit 280 transmits the data stored in the database 270 to the terminal 240.

Meanwhile, if the determining unit 260 determines that the data requested by the terminal 240 is not stored in the database 270, the communication relay unit 280 relays the communication between the terminal 240 and the external communication network 250. The communication relay unit 280 may include a receiving unit 282, a data transmitting unit 284, and a controller 286.

The receiving unit 282 receives the data requested by the terminal 240 from the external communication network 250.

The data transmitting unit 284 transmits the received data to the terminal 240.

The controller 286 controls the received data to be stored in the database 270.

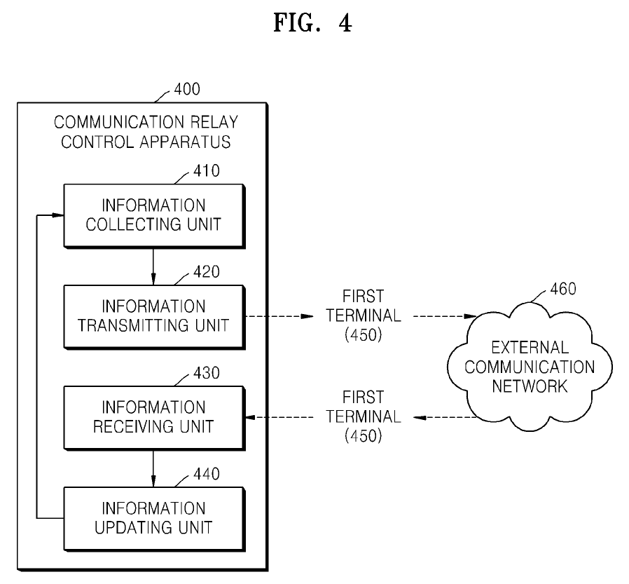

FIG. 4 is a block diagram of a communication relay control apparatus 400 for controlling the communication relay apparatus 200 shown in FIG. 2 according to an embodiment of the present invention. Referring to FIG. 4, the communication relay control apparatus 400 comprises an information collecting unit 410, an information transmitting unit 420, an information receiving unit 430, and an information updating unit 440.

The information collecting unit 410 collects safety policy information of at least one terminal in order to control communication between the at least one terminal and an external communication network 460. The safety policy information may include at least one of first safety policy information used to control the communication between a corresponding terminal and the external communication network 460 and a second safety policy information used to commonly control the communication between the at least one terminal and the external communication network 460.

For example, it is assumed that the first safety policy information includes information on connection limitation to an obscene website A and a game website B and that the second safety policy information includes information on connection limitation on websites C and D from which a virus is detected. Further, the safety policy information is assumed to be related to a first terminal 450. In this regard, the first safety policy information is applied to only the first terminal 450. Thus, although the first terminal 450 does not connect to the obscene website A and the game website B, other terminals can connect to the obscene website A and the game website B. As a result, a specialized safety policy can be applied to each terminal according to the present embodiment. The second safety policy information can be changed by a user of a terminal over a wireless or wired communication network or can be updated by the information updating unit 440.

Meanwhile, the second safety policy information is commonly applied to at least one terminal including the first terminal 450. Thus, the first terminal 450, and a plurality of terminals as well, cannot be connected to the websites C and D. When websites that include a virus or distribute a malicious code are not allowed to connect to terminals, the second safety policy information is used to efficiently apply a safety policy to the plurality of terminals. The first safety policy information can be changed by an external input of a provider managing an external communication network or can be updated by the information updating unit 440.

The communication relay control apparatus 400 further may include a database (not shown) for storing the safety policy information collected by the information collecting unit 410.

The information transmitting unit 420 transmits the safety policy information of the first terminal 450 among the collected safety policy information to the first terminal 450. The safety policy information of the first terminal 450 may include at least one of information on a virus of a predetermined website within the external communication network, malicious code information, and information on a connection limitation to the first terminal 450.

The information receiving unit 430 receives communication detail information relating to the first terminal 450 based on a result of a communication between the first terminal 450 and the external communication network from the first terminal 450.

The information updating unit 440 updates the safety policy information of the first terminal 450 based on the received communication detail information. When the received communication detail information is specialized and applied to the first terminal 450, the information updating unit 440 updates the first safety policy. Meanwhile, when the received communication detail information is commonly applied to all terminals, such as information on a website infecting a terminal with a virus, the information updating unit 440 updates the second safety policy.

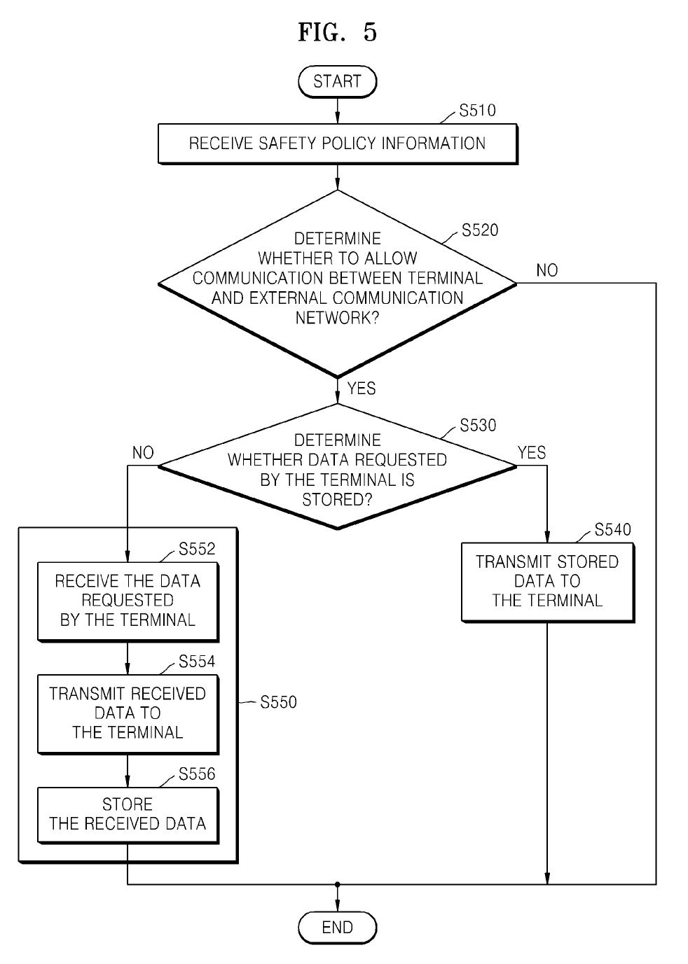

FIG. 5 is a flowchart illustrating a communication relay method according to an embodiment of the present invention. The communication relay method is related to a method of relaying a communication between a terminal and an external communication network.

Referring to FIG. 5, in operation S510, safety policy information of a terminal is received from an external server that stores a plurality of pieces of safety policy information used to control a communication between at least one terminal and an external communication network. The safety policy information includes at least one of virus information on a predetermined address space in the external communication network, malicious code information, and access limit information with regard to the terminal.

In operation S520, it is determined whether to allow the communication between the terminal and the external communication network based on the safety policy information. If the communication between the terminal and the external communication network is allowed, operation S530 is performed. If the communication between the terminal and the external communication network is not allowed, the communication relay process is completed.

In operation S530, it is determined whether data requested by the terminal is stored in a predetermined storage space. If it is determined that the data requested by the terminal is stored in the storage space, operation S540 is performed, and the stored data is transmitted to the terminal. Meanwhile, if it is determined that the data requested by the terminal is not stored in the storage space, operation 550 is performed, and the communication between the terminal and the external communication network is relayed.

Operation S550 may include operations S552 through S556.

In operation S552, the data requested by the terminal is received from the external communication network.

In operation S554, the received data is transmitted to the terminal.

In operation S556, the received data is stored in the predetermined storage space.

The communication relay method of the present embodiment may further comprise generating communication detail information that induces an update of the safety policy information of the terminal based on a result of the communication between the terminal and the external communication network. The communication detail information is transmitted to the external server. The communication relay method can be performed outside the terminal or inside the terminal.

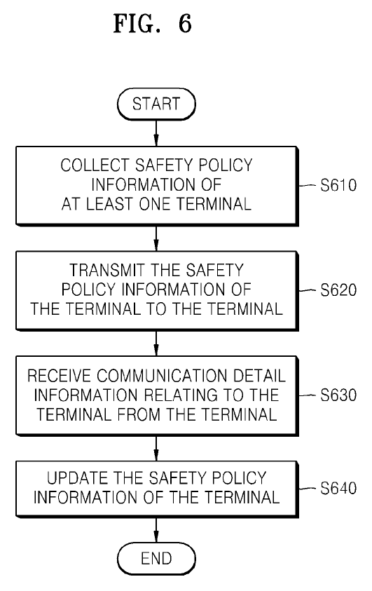

FIG. 6 is a flowchart illustrating a communication relay control method according to an embodiment of the present invention. The communication relay control method of the present embodiment relates to a method of controlling a communication relay between a terminal and an external communication network.

In operation S610, safety policy information of at least one terminal is collected in order to control a communication between the at least one terminal and an external communication network.

In operation S620, the safety policy information of the terminal among the collected safety policy information is transmitted to the terminal.

In operation S630, communication detail information relating to the terminal based on a result of the communication between the terminal and the external communication network is received from the terminal.

In operation S640, the safety policy information of the terminal is updated based on the received communication detail information.

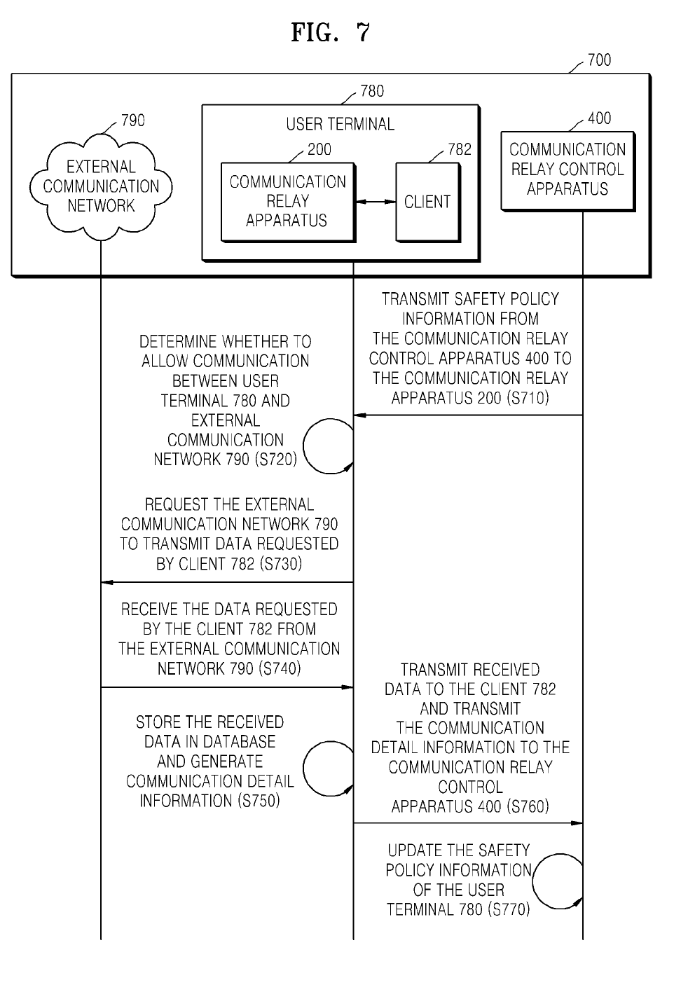

FIG. 7 illustrates an operation of a communication system 700 including the communication relay apparatus 200 and the communication relay control apparatus 400 according to another embodiment of the present invention. Referring to FIG. 7, a user terminal 780 comprises the communication relay apparatus 200 and a client 782. It is described above that although the communication relay apparatus 200 can be included in the user terminal 780, it can be separated from the user terminal 780. The client 782 is referred to as an application program executing in the user terminal 780.

In operation S710, safety policy information of the user terminal 780 is transmitted from the communication relay control apparatus 400 to the communication relay apparatus 200.

In operation S720, if the client 782 requests the communication relay apparatus 200 to connect to an external communication network 790, the communication relay apparatus 200 determines whether to allow a communication between the user terminal 780 and the external communication network 790 based on the safety policy information. If data requested by the user terminal 780 is stored in a storage space of the communication relay apparatus 200, the data is transmitted to the client 782. Meanwhile, if the data requested by the user terminal 780 is not stored in the storage space of the communication relay apparatus 200, operation S730 is performed.

If the communication relay apparatus 200 allows the communication between the user terminal 780 and the external communication network 790, in operation S730, the communication relay apparatus 200 relays the communication between the user terminal 780 and the external communication network 790. That is, the communication relay apparatus 200 requests the external communication network 790 to transmit the data requested by the client 782.

In operation S740, the communication relay apparatus 200 receives the data requested by the client 782 from the external communication network 790.

In operation S750, the communication relay apparatus 200 stores the received data in a database. Further, the communication relay apparatus 200 generates communication detail information that induces the update of the safety policy information of the user terminal 780 based on a result of the communication between the user terminal 780 and the external communication network 790.

In operation S760, the communication relay apparatus 200 transmits data received through the external communication network 790 to the client 782. Further, the communication relay apparatus 200 transmits the communication detail information to the communication relay control apparatus 400.

In operation S770, the communication relay control apparatus 400 updates the safety policy information of the user terminal 780 based on the communication detail information regarding the user terminal 780.

The above embodiments of the present invention can be embodied as a computer readable program and accomplished using a general digital computer via a computer readable recording medium or via a computer readable transmission medium.

The computer readable recording medium may be a magnetic recording medium (a ROM, a floppy disk, a hard disc, etc.) or an optical recording medium (a CD-ROM, a DVD, etc.). The computer readable transmission medium may be, for example, a carrier wave medium that transmits data via the Internet.

According to the present invention, safety policy information of a terminal is received from an external server and a corresponding safety policy is applied to the terminal, thereby applying a specialized safety policy to the terminal.

Each terminal generates communication detail information that induces update of safety policy information, thereby properly updating the safety policy information and easily identifying a website including a virus or a malicious code.

A function of a proxy server can be performed without an external proxy server, thereby reducing costs for maintaining and managing the external proxy server.

A caching function is used to transmit stored data to a terminal, thereby promptly transmitting the data.

While this invention has been particularly shown and described with reference to exemplary embodiments thereof, it will be understood by those of ordinary skill in the art that various changes in form and details may be made therein without departing from the spirit and scope of the invention as defined by the following claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A method of relaying a communication between a terminal and an external communication network, the method comprising:
receiving safety policy information of the terminal from an external server that stores a plurality of pieces of safety policy information used to control a communication between the terminal and the external communication network; and
determining whether to allow the communication between the terminal and the external communication network based on the safety policy information.

2. The method of claim 1, further comprising:
generating communication detail information that induces update of the safety policy information of the terminal based on a result of the communication between the terminal and the external communication network; and
transmitting the communication detail information to the external server.

3. The method of claim 1, wherein the safety policy information includes at least one of virus information on a predetermined address space in the external communication network, malicious code information, and access limit information with regard to the terminal.

4. The method of claim 1, further comprising: if the communication between the terminal and the external communication network is allowed,
determining whether data requested by the terminal is stored in a predetermined storage space; and
selectively relaying the communication between the terminal and the external communication network based on a result of the determination.

5. The method of claim 4, wherein the selectively relaying of the communication comprises: if the data requested by the terminal is stored in the predetermined storage space, transmitting the stored data to the terminal.

6. The method of claim 4, wherein the selectively relaying of the communication comprises: if the data requested by the terminal is not stored in the predetermined storage space,
receiving the data requested by the terminal from the external communication network;
transmitting the received data to the terminal; and
storing the received data in the predetermined storage space.

7. The method of claim 1, wherein at least one of the receiving of the safety policy information and the determining is performed in the terminal.

8. A method of controlling a relay of a communication between a terminal and an external communication network, the method comprising:
collecting safety policy information of the terminal in order to control a communication between the terminal and the external communication network; and
transmitting the safety policy information of the terminal among the collected safety policy information to the terminal.

9. The method of claim 8, further comprising:
receiving communication detail information relating to the terminal from the terminal based on a result of the communication between the terminal and the external communication network; and
updating the safety policy information of the terminal based on the received communication detail information.

10. The method of claim 8, wherein the safety policy information includes at least one of virus information on a predetermined address space in the external communication network, malicious code information, and access limit information with regard to the terminal.

11. The method of claim 8, wherein the safety policy information includes first safety policy information used to control the communication between the terminal and the external communication network and a second safety policy information used to commonly control the communication between the terminal and the external communication network.

12. An apparatus for relaying a communication between a terminal and an external communication network, the apparatus comprising:
a safety policy information receiving unit which receives safety policy information of the terminal from an external server that stores a plurality of pieces of safety policy information used to control a communication between the terminal and the external communication network; and
a communication allowable determining unit which determines whether to allow the communication between the terminal and the external communication network based on the safety policy information.

13. The apparatus of claim 12, further comprising:
an information generating unit which generates communication detail information that induces an update of the safety policy information of the terminal based on a result of the communication between the terminal and the external communication network; and
an information transmitting unit which transmits the communication detail information to the external server.

14. The apparatus of claim 12, wherein the safety policy information includes at least one of virus information on a predetermined address space in the external communication network, malicious code information, and access limit information with regard to the terminal.

15. The apparatus of claim 12, further comprising:
a database which stores data received from the external communication network;
a determining unit, which, if the communication between the terminal and the external communication network is allowed, determines whether data requested by the terminal is stored in a predetermined storage space; and
a communication relay unit which selectively relays the communication between the terminal and the external communication network based on a result of the determination.

16. The apparatus of claim 15, wherein the communication relay unit, which, if the data requested by the terminal is stored in the predetermined storage space, transmits the stored data to the terminal.

17. The apparatus of claim 15, wherein the communication relay unit comprises:
a data receiving unit which receives the data requested by the terminal from the external communication network, if the data requested by the terminal is not stored in the predetermined storage space;
a data transmitting unit which transmits the received data to the terminal; and
a controller which controls the received data to be stored in the predetermined storage space.

18. The apparatus of claim 12, wherein at least one of the safety policy information receiving unit and the communication allowable determining unit is included in the terminal.

19. An apparatus for controlling a relay of a communication between a terminal and an external communication network, the apparatus comprising:
an information collecting unit which collects safety policy information of the terminal in order to control a communication between the terminal and the external communication network; and
an information transmitting unit which transmits the safety policy information of the terminal among the collected safety policy information to the terminal.

20. The apparatus of claim 19, further comprising:
an information receiving unit which receives communication detail information relating to the terminal from the terminal based on a result of the communication between the terminal and the external communication network; and
an information updating unit which updates the safety policy information of the terminal based on the received communication detail information.

21. The apparatus of claim 19, wherein the safety policy information includes at least one of virus information on a predetermined address space in the external communication network, malicious code information, and access limit information with regard to the terminal.

22. The apparatus of claim 19, wherein the safety policy information includes first safety policy information used to control the communication between the terminal and the external communication network and a second safety policy information used to commonly control the communication between a plurality of terminals, including the terminal, and the external communication network.

23. A computer readable medium having recorded thereon a program for executing the method of claim 1.

24. A computer readable medium having recorded thereon a program for executing the method of claim 8.
